(19) United States
(12) Patent Application Publication
(10) Pub. No.: US 2025/0280832 A1
(43) Pub. Date: Sep. 11, 2025

(54) Fungicidal paste

(71) Applicants: Kateryna Skliarenko, Los Angeles, CA (US); Anna Shiriaeva, Los Angeles, CA (US); Viktor Bogdanov, Menden (DE)

(72) Inventors: Kateryna Skliarenko, Los Angeles, CA (US); Anna Shiriaeva, Los Angeles, CA (US); Viktor Bogdanov, Menden (DE)

(21) Appl. No.: 18/600,693

(22) Filed: Mar. 9, 2024

(51) Int. Cl. A01N 59/20; A01N 25/04; A01N 25/24; A01P 3/00

(52) U.S. Cl. CPC A01N 59/20; A01N 25/04; A01N 25/24; A01P 3/00

(57) ABSTRACT

The present invention is a fungicidal paste and method of controlling fungal disease in plants which provides effective application, enhanced adhesion to the plant matter. The fungicidal paste is composed of highly concentrated aqueous suspension of basic copper carbonate with copper content 25-35% w/w (water content 30-50% w/w) with an addition of adhesive substance and microelements.

### FIELD OF THE INVENTION

This invention relates to fungicide, and more particularly to an inorganic fungicide for plants.

### PRIOR ART

Patent citations: Kuprovin-Agro (Patent UA30246 (U) dated 2008 Feb. 25)

Non-patent citations:
1.Stukenbrock, E., & Gurr, S. (2023). Address the growing urgency of fungal disease in crops. Nature, 617(7959), 31-34.
2. Pimentel, D. (2005). Environmental and economic costs of the application of pesticides primarily in the United States. Environment, development and sustainability, 7, 229-252.
3. Steinberg, G., & Gurr, S. J. (2020). Fungi, fungicide discovery and global food security. Fungal Genetics and Biology, 144, 103476.
4. Savary, S., Willocquet, L., Pethybridge, S. J., Esker, P., McRoberts, N., & Nelson, A. (2019). The global burden of pathogens and pests on major food crops. Nature ecology & evolution, 3(3), 430-439.
5. Cuprozin 35 WP (EPA Reg. No 64744-3) in the form of a wettable powder, the active ingredient is copper oxychloride.
6. Champion WG (EPA Reg. No 55146-1) in the form of water-dispersible granules, the active ingredient is copper hydroxide
7. Cuproxat SC (EPA Reg. No 35935-3) in the form of a stable suspension, the active ingredient is basic copper sulfate.

### BACKGROUND OF THE INVENTION

The regulation of fungi is crucial due to the fact that fungal proliferation on plants or plant components hampers the development of foliage, fruit, or seeds, thereby adversely impacting the overall quality of cultivated crops. Growers worldwide lose between 10% and 23% of their crops to fungal disease every year. For instance, fungal disease strongly affects grape production reducing the yield by 12%.

In response to the significant economic implications arising from fungal proliferation in agricultural and horticultural settings, a diverse range of fungicidal and fungistatic products has been formulated for both general and targeted applications. Illustrative instances include the utilization of inorganic bicarbonate, carbonate compounds, organic compounds such as azadirachtin and captan. The present invention increases the adherence of the fungicide to the target plant, increasing fungicidal efficiency and reducing the unwanted environmental spread of the fungicidal compound.

Currently, many commercial fungicides that are used to protect grapes, citrus fruits, olives, apple trees, pears from fungal diseases, including mildew, oidium, scab and others, contain copper compounds.

The disadvantage of most known fungicides is that precipitation and wind disrupts the contact of the fungicide (adhesion) with the treated plant surface and not only intensify the removal of copper into the environment, but also reduce the time beneficial action of fungicides, which necessitates their repeated use to fight diseases. [0006] Currently known methods to increase the adhesion of the fungicide and the chemical activity of copper in its composition results in an increase in energy costs for its production and the cost of the final product.

The main sources of copper for the production of fungicides are:
1. Copper-containing waste resulting from production or use of primary copper obtained from copper ores.
2. Primary metallic copper obtained by processing copper ores.
3. Copper ores.

Copper-containing waste is the most accessible raw material, but requires preliminary purification from harmful impurities and additional technological processes for production and introduction into the composition of the fungicide of adhesive and substances that enhance fungicidal properties of copper and beneficial properties of the fungicide itself.

The use of purified copper metal (cathode copper) is most preferable in terms of minimization of harmful impurities, but this resource is expensive and requires additional technological processes for the production and addition of adhesives and substances into the fungicide composition, enhancing the fungicidal properties of copper and the beneficial properties of the fungicide itself.

Another aspect of the use of copper-based fungicides is the limitation of the migration of copper into the environment and maintaining a neutral pH value of the solution. Therefore, the fungicide must contain copper in the form of insoluble or slightly soluble compounds, and the fungicides themselves are available in the form of wettable powders, water-dispersible granules or suspension concentrates. However, creating such forms also requires additional technological processes and energy costs.

Examples of the known copper fungicides include:
1. Cuprozin 35 WP (EPA Reg. No 64744-3) in the form of a wettable powder, the active ingredient is copper oxychloride.
2. Champion WG (EPA Reg. No 55146-1) in the form of water-dispersible granules, the active ingredient is copper hydroxide
3. Cuproxat SC (EPA Reg. No 35935-3) in the form of a stable suspension, the active ingredient is basic copper sulfate.

The action of these fungicides is also dependent on weather conditions, as solid water-insoluble particles of copper compounds can be carried into the environment and lead to pollution of soil and atmosphere. Moreover, such fungicides require significant resources for their production, which results in their increased cost.

The low-solubility fungicide Kuprovin-Agro (Patent UA30246 (U) dated 2008 Feb. 25). It consists of aqueous solution of basic copper carbonate and is the easiest to prepare. The main disadvantage of this type of fungicide is that it also does not stay on for long enough surfaces of plants, since its action is subject to weather conditions.

The least energy-intensive way to produce copper fungicide in the form of a dispersed system, is the direct production of fungicide from oxidized copper ores.

When leaching oxidized copper ores in hydrochloric acid solution, free silicon oxide from the ore remains in the sediment, and silicon, chemically bound in minerals, can pass into the solution in the form of silicic acid. During the process of precipitation of basic carbonate with sodium carbonate, copper co-precipitates with silicon dioxide hydrogel and other useful elements contained in the ore. The structure of the resulting copper compound is most fully preserved in the original precipitation environment, which includes moisture.

### OBJECTS OF THE INVENTION

The purpose of the current invention is to create a new fungicide with minimal energy production costs and with a long-lasting and efficient action, by reducing the number of technological production processes from natural raw materials to fungicide, and optimizing the composition. Current fungicide is aimed to increase the efficiency of disease control, expand the fungicide use industry.

### SUMMARY OF THE INVENTION

The present invention is a fungicidal paste containing basic copper carbonate formed by precipitation with sodium carbonate from acidic solution, that results from leaching copper from oxidized copper ore with hydrochloric acid. Fungicide paste consists of highly concentrated aqueous suspension of basic copper carbonate (water content 30-50% w/w) with copper ions content 25-25% w/w, with the addition of adhesive and microelements.

During the precipitation process, silicon dioxide hydrogel (silica hydrogel) is formed, its concentration in the paste is 3-5% w/w. Silica hydrogel serves as an adhesive. The paste contains microelements (w/w %): cobalt 0.1-0.3, manganese 0.1-0.3, magnesium 0.1-0.9, iron 0.03-0.05, zinc 0.01.

### DETAILED DESCRIPTION

The claimed fungicide compared with known technical solutions and prototype, among other advantages, allows to minimize energy costs for its production, also allows to reduce the frequency of spraying, and maintains a protective effect on branches and bark of trees, provides a high degree of dispersion, which affects its digestibility by plants. High fungicidal activity is due to using an aqueous solution of basic copper carbonate containing copper ions 25-35 w/w % and 3-5 w/w % silica hydrogel. In addition, the microelements contribute to nourishement of the plant and the soil.

Using a balanced combination of essential microelements allows increase the amount of substances in easily digestible form necessary for nutrition and plant development, thus feeding the plants. Microelements participate in oxidation and reduction reactions, influence the synthesis proteins, carbohydrates and other chemical compounds of plants.

The microelements used are cobalt, manganese, magnesium, iron, zinc, which are used both for foliar feeding of plants and for combating diseases. Thus, the effect of cobalt increases the sugar content of grape berries and affects acceleration of growth, fruit yield, and increases drought resistance of plants. Manganese is involved in the catalytic processes of plants, which affects the quality of the crop and its increase. In addition, it protects grapes from common infectious diseases such as mildew, oidium. Magnesium, which in the fungicide is from 0.1 to 0.9 w/w %, participates in photosynthesis, in the formation of carbohydrates, and is indispensable for plants. Iron promotes the formation of stable complexes with a large amount of organic compounds and is very important for protection and prevention against diseases.

The ratios of the components were established experimentally. Changing the ratio of components from those indicated leads to a deterioration in the structure of the fungicidal paste and negatively affects fungicidal properties. The claimed fungicide paste has a contact effect; it does not penetrate deeply into the plants and does not contribute to the accumulation of heavy metals. It can be used during the growing season and at the same time as a means of foliar feeding. Besides, its consumption for spraying plants is much less, and the duration of action is longer in comparison with other commonly used fungicides.

The fungicide is prepared as follows. Crushed oxidized copper ore is added into hydrochloric acid solution. Metals are leached. After reaching the required solution concentration, the solution is separated from the sludge and precipitation of basic copper carbonate from the solution using sodium carbonate (soda ash). After washing on a filter press and squeezing the sediment to a humidity of 30-50%, a ready-made fungicide is obtained in the form of a paste, which contains an adhesive and useful microelements. To obtain a working suspension of fungicide for use (spraying plants) basic copper carbonate is mixed with water. Consumption of working solution per hectare of vineyard or garden—from 200 to 800 l. In this case, 3-5 kg of basic copper carbonate is mixed with water.

Experimental studies have shown that the claimed fungicide has higher efficiency than known ones. Copper efficiency in the claimed fungicide is 25% higher than in the fungicide Cuproxat SC and 15% higher than in the prototype “Kuprovin-Agro”. It allows you to reduce the number of treatments, increase harvest, protects plants from fungal diseases, nourishes the plant and the soil. At the same time, the energy costs for the production of the claimed fungicide are at least 2 times lower compared to analogues.

What is claimed is:

1. The method of preparing fungicide paste comprising the following steps:
Crushed oxidized copper ore is added into a hydrochloric acid solution, where metals are leached;
After reaching the required solution concentration, the solution is separated from the sludge;
Precipitation of basic copper carbonate from the solution is achieved using sodium carbonate (soda ash);
After washing on a filter press and squeezing the sediment to a humidity of 30-50%, a ready-made fungicide is obtained in the form of a paste, which contains adhesive and useful microelements.

2. The method of claim 1 that uses copper-containing waste products from the copper mining industry as starting material.

3. Composition of fungicide paste prepared by the method of claim1 in the form of highly concentrated aqueous suspension of basic copper carbonate (water content 30-50% w/w with copper ions content 25-35% w/w, with the addition of adhesive and microelements).

4. The composition of paste in the form of highly concentrated aqueous suspension of basic copper carbonate (water content 30-50% w/w with copper ions content 25-35% w/w, with the addition of adhesive and microelements), prepared by the method of claim 1 or 2, further comprising silica hydrogel 3-5% w/w that serves as an adhesive and is coprecipitated with basic copper carbonate.

5. The composition of paste in the form of highly concentrated aqueous suspension of basic copper carbonate (water content 30-50% w/w with copper ions content 25-35% w/w, with the addition of adhesive and microelements), prepared by the method of claim 1 or 2, further comprising the following microelements (w/w %): cobalt 0.1-0.3, manganese 0.1-0.3, magnesium 0.1-0.9, iron 0.03-0.05, zinc 0.01 coprecipitated with basic copper carbonate.

6. A method for treating, inhibiting, and controlling plant fungal disease that involves contacting a plant with a fungicide solution resuspended in water in ratio 3-5 kg of paste per 200-800L of water applied to 1 hectare of vineyard or garden.
